(19) United States
(12) Patent Application Publication
(10) Pub. No.: US 2022/0319141 A1
(43) Pub. Date: Oct. 6, 2022

(54) METHOD FOR PROCESSING IMAGE, DEVICE AND STORAGE MEDIUM

(71) Applicant: Beijing Baidu Netcom Science Technology Co., Ltd., Beijing (CN)

(72) Inventors: Fanglong LIU, Beijing (CN); Xin LI, Beijing (CN); Dongliang HE, Beijing (CN)

(21) Appl. No.: 17/845,843

(22) Filed: Jun. 21, 2022

(30) Foreign Application Priority Data
Sep. 15, 2021 (CN) 202111082093.3

(51) Int. Cl. G06V 10/22; G06T 7/11; H04N 19/174

(52) U.S. Cl. CPC G06V 10/22; G06T 7/11; H04N 19/174; G06T 2207/10004

(57) ABSTRACT

A methods for processing an image, a device, and a storage medium are provided. The method may include: inputting a target image into a pre-trained image segmentation model, the target image including at least one sub-image; extracting high-level semantic features and low-level features of the target image through the image segmentation model, and determining target location information of the sub-image in the target image based on the high-level semantic features and the low-level features; and performing a preset processing operation on the sub-image, based on the target location information of the sub-image.

### CROSS-REFERENCE TO RELATED APPLICATIONS

The present application claims the priority of Chinese Patent Application No. 202111082093.3, titled “METHOD AND APPARATUS FOR PROCESSING IMAGE, DEVICE AND STORAGE MEDIUM”, filed on Sep. 15, 2021, the content of which is incorporated herein by reference in its entirety.

### TECHNICAL FIELD

The present disclosure relates to the field of artificial intelligence technology, in particular to computer vision and deep learning technologies, which may be used in intelligent cropping scenarios.

### BACKGROUND

In some image application scenarios, a larger image may contain at least one smaller sub-image, a position of the sub-image in the larger image needs to be determined, and the sub-image is processed accordingly based on the position of the sub-image. In the existing technology, it is usually necessary to determine the position of the sub-image in the larger image by human judgment, and then the position of the sub-image is manually marked.

### SUMMARY

The present disclosure provides a method for processing an image, a device and a storage medium.

According to a first aspect of the disclosure, a method for processing an image is provided, which includes:

inputting a target image into a pre-trained image segmentation model, the target image including at least one sub-image;

extracting high-level semantic features and low-level features of the target image through the image segmentation model, and determining target location information of the sub-image in the target image based on the high-level semantic features and the low-level features; and

performing a preset processing operation on the sub-image, based on the target location information of the sub-image.

According to a second aspect of the disclosure, an electronic device is provided, which includes:

at least one processor; and

a memory communicatively connected to the at least one processor; wherein

the memory stores instructions executable by the at least one processor, and the instructions, when executed by the at least one processor, cause the at least one processor to perform the method for processing an image.

According to a third aspect of the disclosure, a non-transitory computer readable storage medium storing computer instructions is provided, where, the computer instructions are used to cause the computer to perform the method for processing an image.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

The accompanying drawings are used for better understanding of the present solution, and do not constitute a limitation to the present disclosure. In which:

FIG. 1 shows a schematic flowchart of a method for processing an image provided by an embodiment of the present disclosure;

FIG. 2 shows a schematic flowchart of another method for processing an image provided by an embodiment of the present disclosure;

FIG. 3 shows an example schematic diagram of a target image provided by an embodiment of the present disclosure;

FIG. 4 shows a schematic diagram of an apparatus for processing an image provided by an embodiment of the present disclosure; and

FIG. 5 shows a schematic block diagram of an example electronic device that may be adapted to implement the method for processing an image provided by embodiments of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description.

In some image application scenarios, a larger image may contain at least one smaller sub-image, a position of the sub-image in the larger image needs to be determined, and the sub-image is processed accordingly based on the position of the sub-image. In the existing technology, it is usually necessary to determine the position of the sub-image in the larger image by human judgment, and then the position of the sub-image is manually marked. This approach for processing an image requires much time and economic costs, which also leads to low image processing efficiency.

A method and apparatus for processing an image, a device, and a storage medium provided by the embodiments of the present disclosure are intended to solve at least one of the above technical problems in the existing technology.

The present disclosure provides a pre-trained image segmentation model, based on which the method for processing an image provided by the present disclosure may be performed. When training the image segmentation model, a plurality of sample images may be pre-acquired as a training set, where each sample image includes at least one sub-image, and then the image segmentation model may be trained based on the training set.

In particular, supervised training of the image segmentation model may be performed based on the training set. Specifically, the sample images in the training set are input into the image segmentation model, and location information of the sub-images in the sample images output by the image segmentation model are used. Then, the location information of the sub-images in the sample images output by the image segmentation model is compared with actual location information of the sub-images to obtain a loss function, and a parameter of the image segmentation model is adjusted based on the loss function. When the loss function reaches a preset loss value, the training process for the image segmentation model ends.

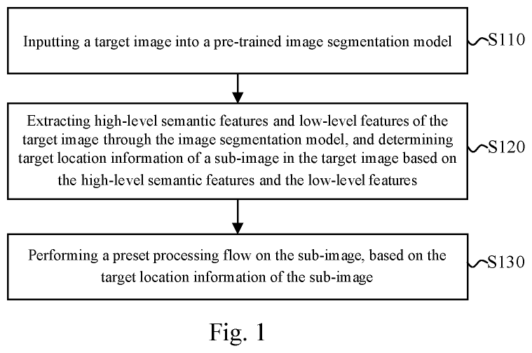

FIG. 1 shows a schematic flowchart of a method for processing an image provided by an embodiment of the present disclosure, as shown in FIG. 1, the method may mainly include the following steps.

S110 includes: inputting a target image into a pre-trained image segmentation model.

In an embodiment of the present disclosure, the target image includes at least one smaller sub-image. The number of sub-images included in the target image is not limited, and the sizes and shapes of different sub-images may be the same or different. Here, the target image may be an unprocessed original image, or an image obtained by resizing the original image.

Alternatively, in an embodiment of the present disclosure, before inputting the target image into the pre-trained image segmentation model, an original image to be processed may be acquired, and the original image may be scaled as the target image with a preset aspect ratio. Here, the preset aspect ratio is consistent with an aspect ratio of the sample image used in the training process of the image segmentation model. For example, if the aspect ratio of the sample image used by the segmentation model in the training process is 2:1, the original image needs to be scaled to the target image with the aspect ratio of 2:1, which may ensure that the target image is consistent with the sample image, thereby ensuring the accuracy of a result for the target image output by the image segmentation model.

Alternatively, in an embodiment of the present disclosure, when inputting the target image into the pre-trained image segmentation model, the target image may be cropped into a plurality of image blocks, and the plurality of image blocks may be input into the pre-trained image segmentation model.

S120 includes: extracting high-level semantic features and low-level features of the target image through the image segmentation model, and determining target location information of the sub-image in the target image based on the high-level semantic features and the low-level features.

In an embodiment of the present disclosure, the high-level semantic features of an image refer to what we can see. For example, by extracting low-level features for a human face, we may extract a face contour, nose, eyes, etc., then the high-level semantic features are displayed as a human face. High-level feature semantic information is rich, but a target location is relatively rough. It may be understood that a higher level feature has a stronger high-level semantic, and has a better discrimination ability.

The low-level features of an image refer to contour, edge, color, texture and shape features, etc. The low-level features have little feature semantic information, but the target location is accurate. Based on the high-level semantic features and low-level features, more accurate location information of the sub-image can be determined from the target image.

As described above, in an embodiment of the present disclosure, the target image may be cropped into a plurality of image blocks, and the plurality of image blocks may be input into the pre-trained image segmentation model. Therefore, in an embodiment of the present disclosure, when extracting high-level semantic features and low-level features of the target image through the image segmentation model, high-level semantic features and low-level features of each of the image blocks may be extracted through the image segmentation model. When determining target location information of the sub-image in the target image based on the high-level semantic features and the low-level features, sub-location information of a sub-region including at least part of the sub-image in the image block may be determined based on the high-level semantic features and the low-level features of the image block; and the target location information of the sub-image in the target image may be determined based on the sub-location information corresponding to at least one of the image blocks.

S130 includes: performing a preset processing operation on the sub-image, based on the target location information of the sub-image.

It may be understood that a specific content of the processing operation performed on the sub-image may be determined based on an actual application scenario. For example, operations such as delete, replace, insert and connect, and retrieve may be performed based on the target location information of the sub-image.

Alternatively, in an embodiment of the present disclosure, the sub-image may be deleted from the target image based on the target location information of the sub-image, and a new sub-image may be inserted at an original location of the deleted sub-image.

Alternatively, in an embodiment of the present disclosure, the sub-image may be cropped from the target image based on the target location information of the sub-image, and the sub-image may be retrieved based on a preset image library.

Alternatively, in an embodiment of the present disclosure, a region in the target image indicated by the target location information of the sub-image may be associated with a preset link.

The method for processing an image provided by an embodiment of the present disclosure, the high-level semantic features and the low-level features of the target image may be extracted through the pre-trained image segmentation model, and accurate location information of the sub-image may be automatically determined from the target image based on these two kinds of features. Therefore, it is convenient to perform a further processing operation based on the location information of the sub-image. The above process of determining the location information of the sub-image is faster, and an accuracy of the location information is higher, which helps to reduce time and economic costs.

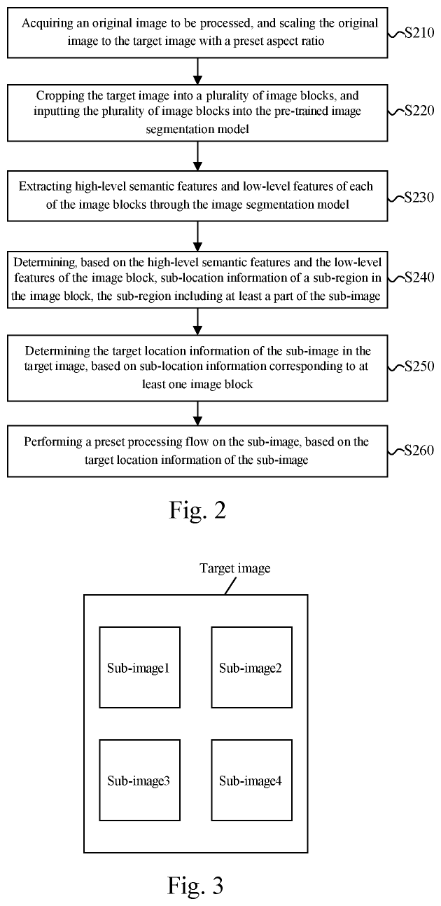

FIG. 2 shows a schematic flowchart of another method for processing an image provided by an embodiment of the present disclosure, as shown in FIG. 2, the method may mainly include the following steps.

S210 includes: acquiring an original image to be processed, and scaling the original image as a target image with a preset aspect ratio.

Here, the preset aspect ratio is consistent with an aspect ratio of the sample image used in the training process of the image segmentation model. For example, if the aspect ratio of the sample image used in training the segmentation model is 2:1, the original image needs to be scaled as a target image with the aspect ratio of 2:1, which may ensure that the target image is consistent with the sample image, thereby ensuring the accuracy of a result output for the target image by the image segmentation model.

Alternatively, in the present disclosure, when scaling the original image as the target image with the preset aspect ratio in real time, a width of the original image may be kept unchanged, a length of the original image may be scaled based on the preset aspect ratio to obtain the target image with the preset aspect ratio. For example, if the length and the width of the original image are 30 and 10 respectively, the preset aspect ratio is 2:1, then it only needs to keep the width of the original image unchanged and adjust the length of the original image to 20.

S220 includes: cropping the target image into a plurality of image blocks, and inputting the plurality of image blocks into the pre-trained image segmentation model.

In an embodiment of the present disclosure, the target image includes at least one smaller sub-image. The number of sub-images included in the target image is not limited, and the sizes and shapes of different sub-images may be the same or different. FIG. 3 shows an example schematic diagram of a target image provided by an embodiment of the present disclosure. As shown in FIG. 3, the target image includes 4 sub-images (sub-image 1 to sub-image 4), and the 4 sub-images are squares having the same shape and size.

It may be understood that after the target image is cropped into the plurality of image blocks, some image blocks may include part of the content of the sub-images, and other image blocks may not include any part of the sub-images. The number and size of the image blocks cropped based on the target image may be determined according to actual design requirements. For example, the size of the target image is 321*481, the size of the image block is 50*50, and a sliding step during cropping is 35, then 126 image blocks may be obtained.

S230 includes: extracting high-level semantic features and low-level features of each of the image blocks through the image segmentation model.

In an embodiment of the present disclosure, the high-level semantic features of an image refer to what we can see. For example, by extracting low-level features for a human face, we may extract a face contour, nose, eyes, etc., then the high-level semantic features are displayed as a human face. High-level feature semantic information is rich, but a target location is relatively rough. It may be understood that a higher level feature has a stronger high-level semantic, and has a better discrimination ability.

The low-level features of an image refer to contour, edge, color, texture and shape features, etc. The low-level features have little feature semantic information, but the target location is accurate. Based on the high-level semantic features and low-level features, more accurate location information of the sub-image can be determined from the target image. In this step, at least one high-level semantic feature and at least one low-level feature of each of the image blocks may be extracted through the image segmentation model. It may be understood that the number of high-level semantic features and the number of low-level features extracted are the same, and each high-level semantic feature has a same resolution as a corresponding low-level feature. For example, 3 high-level semantic features and 3 low-level features of each image block may be extracted through the image segmentation model. The high-level semantic features are in one-to-one correspondence with the low-level features, and a resolution of the high-level semantic features is the same as the resolution of the low-level feature corresponding to the high-level semantic feature.

S240 includes: determining, based on the high-level semantic features and the low-level features of the image block, sub-location information of a sub-region that includes at least part of the sub-image in the image block.

As described above, each high-level semantic feature has the same resolution as a corresponding low-level feature. In step 240, the high-level semantic feature and the low-level feature of the image block having the same resolution may be fused to obtain a fusion feature. Then, the sub-location information of the sub-region that includes at least part of the sub-image in the image block may be determined, based on the fusion feature. In an embodiment of the present disclosure, a region in the image block having part of the sub-image is defined as the sub-region. It may be understood that sub-regions in the plurality of image blocks may be spliced into a complete sub-image.

S250 includes: determining the target location information of the sub-image in the target image, based on the sub-location information corresponding to at least one of the image blocks.

As described above, the image blocks are cropped from the target image, and the sub-regions in the plurality of image blocks may be spliced into a complete sub-image.

Therefore, by integrating the sub-location information of each part of the sub-image in the image blocks, the target location information of the sub-image in the target image may be obtained.

S260 includes: performing a preset processing operation on the sub-image, based on the target location information of the sub-image.

It may be understood that a specific content of the processing operation performed on the sub-image may be determined based on an actual application scenario. For example, operations such as delete, replace, insert and connect, and retrieve may be performed based on the target location information of the sub-image.

Alternatively, in an embodiment of the present disclosure, the sub-image may be deleted from the target image based on the target location information of the sub-image, and a new sub-image may be inserted at an original location of the deleted sub-image, thereby realizing replacement of the sub-image.

Alternatively, in an embodiment of the present disclosure, the sub-image may be cropped from the target image based on the target location information of the sub-image, and the sub-image may be retrieved based on a preset image library. For example, the method may be applied in a copyright screening scenario. When no sub-image is retrieved from the image library, it may be determined that the sub-image does not infringe the copyright of a third party.

Alternatively, in an embodiment of the present disclosure, a region in the target image indicated by the target location information of the sub-image may be associated with a preset link. Here, when a user clicks on the region indicated by the target location information of the sub-image, content corresponding to the link may be displayed. Alternatively, the content corresponding to the link may be content such as advertisements.

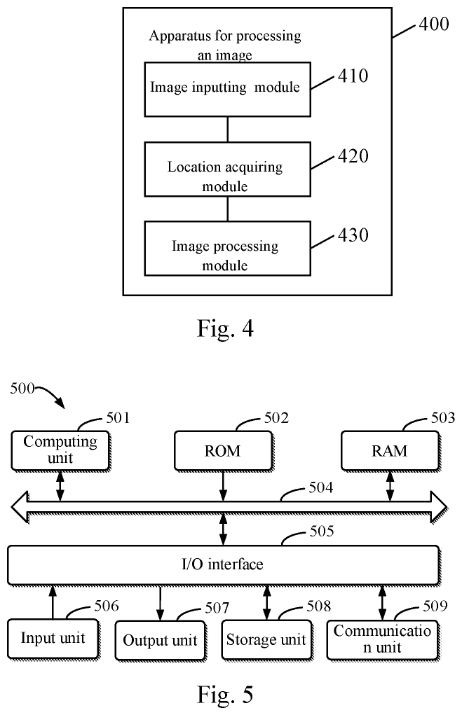

Based on the same principle as the above method for processing an image, FIG. 4 shows a schematic diagram of an apparatus for processing an image provided by an embodiment of the present disclosure. As shown in FIG. 4, the apparatus 400 for processing an image includes an image inputting module 410, a location acquiring module 420 and an image processing module 430.

The image inputting module 410 is configured to input a target image into a pre-trained image segmentation model, the target image including at least one sub-image.

The location acquiring module 420 is configured to extract high-level semantic features and low-level features of the target image through the image segmentation model, and determine target location information of the sub-image in the target image based on the high-level semantic features and the low-level features.

The image processing module 430 is configured to perform a preset processing operation on the sub-image, based on the target location information of the sub-image.

The apparatus for processing an image provided by an embodiment of the present disclosure, the high-level semantic features and the low-level features of the target image may be extracted through the pre-trained image segmentation model, and accurate location information of the sub-image may be automatically determined from the target image based on these two kinds of features. Therefore, it is convenient to perform a further processing operation based on the location information of the sub-image. The above process of determining the location information of the sub-image is faster, and an accuracy of the location information is higher, which helps to reduce time and economic costs.

In an embodiment of the present disclosure, the image inputting module 410 is configured to input a target image into a pre-trained image segmentation model, by being specifically configured to:

crop the target image into a plurality of image blocks, and input the plurality of image blocks into the pre-trained image segmentation model.

In an embodiment of the present disclosure, the location acquiring module 420 is configured to extract high-level semantic features and low-level features of the target image through the image segmentation model, by being specifically configured to: extract high-level semantic features and low-level features of each of the image blocks through the image segmentation model.

In an embodiment of the present disclosure, the location acquiring module 420 is configured to determine target location information of the sub-image in the target image based on the high-level semantic features and the low-level features, by being specifically configured to: determine, based on the high-level semantic features and the low-level features of the image block, sub-location information of a sub-region that includes at least part of the sub-image in the image block; and determine the target location information of the sub-image in the target image, based on the sub-location information corresponding to at least one of the image blocks.

In an embodiment of the present disclosure, the location acquiring module 420 is configured to extract high-level semantic features and low-level features of each of the image blocks through the image segmentation model, by being specifically configured to: extract at least one high-level semantic feature and at least one low-level feature of each of the image blocks through the image segmentation model, where each high-level semantic feature has a same resolution as a corresponding low-level feature.

In an embodiment of the present disclosure, the location acquiring module 420 is configured to determine, based on the high-level semantic features and the low-level features of the image block, sub-location information of a sub-region that includes at least part of the sub-image in the image block, by being specifically configured to: fuse the high-level semantic feature and the low-level feature of the image block having the same resolution to obtain a fusion feature; and determine the sub-location information of the sub-region including at least part of the sub-image in the image block, based on the fusion feature.

In an embodiment of the present disclosure, the image inputting module 410 is further configured to: acquire an original image to be processed, and scale the original image as a target image with a preset aspect ratio;

where, the preset aspect ratio is consistent with an aspect ratio of a sample image used in a training process of the image segmentation model.

In an embodiment of the present disclosure, the image inputting module 410 is configured to scale the original image as the target image with a preset aspect ratio, by being specifically configured to: keep a width of the original image unchanged, and scale a length of the original image based on the preset aspect ratio to obtain the target image with the preset aspect ratio.

In an embodiment of the present disclosure, the image processing module 430 is configured to perform a preset processing operation on the sub-image, based on the target location information of the sub-image, by being specifically configured to perform at least one of:

deleting the sub-image from the target image based on the target location information of the sub-image, and inserting a new sub-image at an original location of the deleted sub-image;

cropping the sub-image from the target image based on the target location information of the sub-image, and retrieving the sub-image based on a preset image library; or

associating a region in the target image indicated by the target location information of the sub-image with a preset link.

It may be understood that the above modules of the apparatus for processing an image in the embodiments of the present disclosure have the function of implementing the corresponding steps of the above method for processing an image. The function may be implemented by hardware or by executing corresponding software by hardware. The hardware or software includes one or more modules corresponding to the above function. The above modules may be software and/or hardware, and the above modules may be implemented independently, or a plurality of modules may be integrated and implemented. For a functional description of each module of the apparatus for processing an image, reference may be made to the corresponding description of the above method for processing an image, and detailed description thereof will be omitted.

In the technical solution of the present disclosure, the acquisition, storage and application of the user personal information involved are all in accordance with the provisions of the relevant laws and regulations, and the public order and good customs are not violated.

According to an embodiment of the present disclosure, the present disclosure also provides an electronic device, a readable storage medium, and a computer program product. The high-level semantic features and the low-level features of the target image may be extracted through the pre-trained image segmentation model, and accurate location information of the sub-image may be automatically determined from the target image based on these two kinds of features. Therefore, it is convenient to perform a further processing operation based on the location information of the sub-image. The above process of determining the location information of the sub-image is faster, and an accuracy of the location information is higher, which helps to reduce time and economic costs.

FIG. 5 shows a schematic block diagram of an example electronic device that may be used to implement the method for processing an image provided by embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 5, the electronic device 500 includes a computing unit 501, which may perform various appropriate actions and processing, based on a computer program stored in a read-only memory (ROM) 502 or a computer program loaded from a storage unit 508 into a random access memory (RAM) 503. In the RAM 503, various programs and data required for the operation of the electronic device 500 may also be stored. The computing unit 501, the ROM 502, and the RAM 503 are connected to each other through a bus 504. An input/output (I/O) interface 505 is also connected to the bus 504.

A plurality of parts in the electronic device 500 are connected to the I/O interface 505, including: an input unit 506, for example, a keyboard and a mouse; an output unit 507, for example, various types of displays and speakers; the storage unit 508, for example, a disk and an optical disk; and a communication unit 509, for example, a network card, a modem, or a wireless communication transceiver. The communication unit 509 allows the electronic device 500 to exchange information/data with other devices over a computer network such as the Internet and/or various telecommunication networks.

The computing unit 501 may be various general-purpose and/or dedicated processing components having processing and computing capabilities. Some examples of the computing unit 501 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 501 performs the various methods and processes described above, such as the method for processing an image. For example, in some embodiments, the method for processing an image may be implemented as a computer software program, which is tangibly included in a machine readable medium, such as the storage unit 508. In some embodiments, part or all of the computer program may be loaded and/or installed on the electronic device 500 via the ROM 502 and/or the communication unit 509. When the computer program is loaded into the RAM 503 and executed by the computing unit 501, one or more steps of the method for processing an image described above may be performed. Alternatively, in other embodiments, the computing unit 501 may be configured to perform the method for processing an image by any other appropriate means (for example, by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include: being implemented in one or more computer programs, where the one or more computer programs may be executed and/or interpreted on a programmable system including at least one programmable processor, and the programmable processor may be a specific-purpose or general-purpose programmable processor, which may receive data and instructions from a storage system, at least one input apparatus and at least one output apparatus, and send the data and instructions to the storage system, the at least one input apparatus and the at least one output apparatus.

Program codes for implementing the method of the present disclosure may be compiled using any combination of one or more programming languages. The program codes may be provided to a processor or controller of a general purpose computer, a specific purpose computer, or other programmable apparatuses for data processing, such that the program codes, when executed by the processor or controller, cause the functions/operations specified in the flowcharts and/or block diagrams to be implemented. The program codes may be completely executed on a machine, partially executed on a machine, partially executed on a machine and partially executed on a remote machine as a separate software package, or completely executed on a remote machine or server.

In the context of the present disclosure, a machine readable medium may be a tangible medium which may contain or store a program for use by, or used in combination with, an instruction execution system, apparatus or device. The machine readable medium may be a machine readable signal medium or a machine readable storage medium. The computer readable medium may include, but is not limited to, electronic, magnetic, optical, electromagnetic, infrared, or semiconductor systems, apparatuses, or devices, or any appropriate combination of the above. A more specific example of the machine readable storage medium will include an electrical connection based on one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any appropriate combination of the above.

To provide interaction with a user, the systems and technologies described herein may be implemented on a computer that is provided with: a display apparatus (e.g., a CRT (cathode ray tube) or an LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or tactile feedback); and an input may be received from the user in any form (including an acoustic input, a voice input, or a tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and server are generally far away from each other and usually interact through a communication network. The relationship between the client and the server is generated by computer programs running on the corresponding computers and having a client server relationship with each other. The server can be a cloud server, a distributed system server, or a blockchain server.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for processing an image, the method comprising:
inputting a target image into a pre-trained image segmentation model, the target image including at least one sub-image;
extracting high-level semantic features and low-level features of the target image through the image segmentation model, and determining target location information of the sub-image in the target image based on the high-level semantic features and the low-level features; and
performing a preset processing operation on the sub-image, based on the target location information of the sub-image.

2. The method according to claim 1, wherein inputting the target image into the pre-trained image segmentation model comprises:
cropping the target image into a plurality of image blocks, and inputting the plurality of image blocks into the pre-trained image segmentation model.

3. The method according to claim 2, wherein,
extracting the high-level semantic features and the low-level features of the target image through the image segmentation model comprises:
extracting high-level semantic features and low-level features of each of the image blocks through the image segmentation model;
determining the target location information of the sub-image in the target image based on the high-level semantic features and the low-level features comprises:
determining, based on the high-level semantic features and the low-level features of the image block, sub-location information of a sub-region including at least part of the sub-image in the image block; and
determining the target location information of the sub-image in the target image, based on the sub-location information corresponding to at least one of the image blocks.

4. The method according to claim 3, wherein extracting the high-level semantic features and the low-level features of each of the image blocks through the image segmentation model comprises:
extracting at least one high-level semantic feature and at least one low-level feature of each of the image blocks through the image segmentation model, wherein each high-level semantic feature has a same resolution as a corresponding low-level feature;
determining, based on the high-level semantic features and the low-level features of the image block, the sub-location information of the sub-region including at least part of the sub-image in the image block, comprises:
fusing the high-level semantic feature and the low-level feature of the image block having the same resolution to obtain a fusion feature; and
determining the sub-location information of the sub-region including at least part of the sub-image in the image block, based on the fusion feature.

5. The method according to claim 1, wherein, before inputting the target image into the pre-trained image segmentation model, the method further comprises:
acquiring an original image to be processed, and scaling the original image as the target image with a preset aspect ratio;
wherein the preset aspect ratio is consistent with an aspect ratio of a sample image used in a training process of the image segmentation model.

6. The method according to claim 5, wherein scaling the original image to the target image with the preset aspect ratio comprises:
keeping a width of the original image unchanged, and scaling a length of the original image based on the preset aspect ratio to obtain the target image with the preset aspect ratio.

7. The method according to claim 1, wherein performing the preset processing operation on the sub-image, based on the target location information of the sub-image, comprises at least one of:
deleting the sub-image from the target image based on the target location information of the sub-image, and inserting a new sub-image at an original location of the deleted sub-image;
cropping the sub-image from the target image based on the target location information of the sub-image, and retrieving the sub-image based on a preset image library; or
associating a region in the target image indicated by the target location information of the sub-image with a preset link.

8. An electronic device, comprising:
at least one processor; and
a memory communicatively connected to the at least one processor; wherein
the memory stores instructions executable by the at least one processor, and the instructions, when executed by the at least one processor, cause the at least one processor to perform operations comprising:
inputting a target image into a pre-trained image segmentation model, the target image including at least one sub-image;
extracting high-level semantic features and low-level features of the target image through the image segmentation model, and determining target location information of the sub-image in the target image based on the high-level semantic features and the low-level features; and
performing a preset processing operation on the sub-image, based on the target location information of the sub-image.

9. The electronic device according to claim 8, wherein inputting the target image into the pre-trained image segmentation model comprises:
cropping the target image into a plurality of image blocks, and inputting the plurality of image blocks into the pre-trained image segmentation model.

10. The electronic device according to claim 9, wherein
extracting the high-level semantic features and the low-level features of the target image through the image segmentation model comprises:
extracting high-level semantic features and low-level features of each of the image blocks through the image segmentation model;
determining the target location information of the sub-image in the target image based on the high-level semantic features and the low-level features comprises:
determining, based on the high-level semantic features and the low-level features of the image block, sub-location information of a sub-region including at least part of the sub-image in the image block; and
determining the target location information of the sub-image in the target image, based on the sub-location information corresponding to at least one of the image blocks.

11. The electronic device according to claim 10, wherein extracting the high-level semantic features and the low-level features of each of the image blocks through the image segmentation model comprises:
extracting at least one high-level semantic feature and at least one low-level feature of each of the image blocks through the image segmentation model, wherein each high-level semantic feature has a same resolution as a corresponding low-level feature;
determining, based on the high-level semantic features and the low-level features of the image block, the sub-location information of the sub-region including at least part of the sub-image in the image block, comprises:
fusing the high-level semantic feature and the low-level feature of the image block having the same resolution to obtain a fusion feature; and
determining the sub-location information of the sub-region including at least part of the sub-image in the image block, based on the fusion feature.

12. The electronic device according to claim 8, wherein before inputting the target image into the pre-trained image segmentation model, the operations further comprise:
acquiring an original image to be processed, and scaling the original image as the target image with a preset aspect ratio;
wherein the preset aspect ratio is consistent with an aspect ratio of a sample image used in a training process of the image segmentation model.

13. The electronic device according to claim 12, wherein scaling the original image to the target image with the preset aspect ratio comprises:
keeping a width of the original image unchanged, and scaling a length of the original image based on the preset aspect ratio to obtain the target image with the preset aspect ratio.

14. The electronic device according to claim 8, wherein performing the preset processing operation on the sub-image, based on the target location information of the sub-image, comprises at least one of:
deleting the sub-image from the target image based on the target location information of the sub-image, and inserting a new sub-image at an original location of the deleted sub-image;
cropping the sub-image from the target image based on the target location information of the sub-image, and retrieving the sub-image based on a preset image library; or
associating a region in the target image indicated by the target location information of the sub-image with a preset link.

15. A non-transitory computer readable storage medium storing computer instructions, wherein, the computer instructions are used to cause the computer to perform operations comprising:
inputting a target image into a pre-trained image segmentation model, the target image including at least one sub-image;
extracting high-level semantic features and low-level features of the target image through the image segmentation model, and determining target location information of the sub-image in the target image based on the high-level semantic features and the low-level features; and
performing a preset processing operation on the sub-image, based on the target location information of the sub-image.

16. The storage medium according to claim 15, wherein inputting the target image into the pre-trained image segmentation model comprises:
cropping the target image into a plurality of image blocks, and inputting the plurality of image blocks into the pre-trained image segmentation model.

17. The storage medium according to claim 16, wherein extracting the high-level semantic features and the low-level features of the target image through the image segmentation model comprises:
extracting high-level semantic features and low-level features of each of the image blocks through the image segmentation model;
determining the target location information of the sub-image in the target image based on the high-level semantic features and the low-level features comprises:
determining, based on the high-level semantic features and the low-level features of the image block, sub-location information of a sub-region including at least part of the sub-image in the image block; and
determining the target location information of the sub-image in the target image, based on the sub-location information corresponding to at least one of the image blocks.

18. The storage medium according to claim 17, wherein extracting the high-level semantic features and the low-level features of each of the image blocks through the image segmentation model comprises:
extracting at least one high-level semantic feature and at least one low-level feature of each of the image blocks through the image segmentation model, wherein each high-level semantic feature has a same resolution as a corresponding low-level feature;
determining, based on the high-level semantic features and the low-level features of the image block, the sub-location information of the sub-region including at least part of the sub-image in the image block, comprises:
fusing the high-level semantic feature and the low-level feature of the image block having the same resolution to obtain a fusion feature; and
determining the sub-location information of the sub-region including at least part of the sub-image in the image block, based on the fusion feature.

19. The storage medium according to claim 15, wherein before inputting the target image into the pre-trained image segmentation model, the operations further comprise:
acquiring an original image to be processed, and scaling the original image as the target image with a preset aspect ratio;
wherein the preset aspect ratio is consistent with an aspect ratio of a sample image used in a training process of the image segmentation model.

20. The storage medium according to claim 19, wherein scaling the original image to the target image with the preset aspect ratio comprises:
keeping a width of the original image unchanged, and scaling a length of the original image based on the preset aspect ratio to obtain the target image with the preset aspect ratio.
